(19) United States
(12) Patent Application Publication
(10) Pub. No.: US 2013/0175859 A1
(43) Pub. Date: Jul. 11, 2013

(54) NETWORK APPARATUS WITH COMMON POWER INTERFACE

(71) Applicant: CARRY TECHNOLOGY CO., LTD., New Taipei City (TW)

(72) Inventors: LIN TIEN, Taipei City (TW); Ying-Ching Lee, New Taipei City (TW); King-Foo Wong, Taipei City (TW); Taron Chang, New Taipei City (TW); Tsung-Che Wu, Kaohsiung City (TW); Ching-Yun Ou Yang, New Taipei City (TW)

(73) Assignee: CARRY TECHNOLOGY CO., LTD., New Taipei City (TW)

(21) Appl. No.: 13/682,723

(22) Filed: Nov. 20, 2012

(30) Foreign Application Priority Data
Jan. 9, 2012 (TW) 101200492

(51) Int. Cl. H02J 1/00

(52) U.S. Cl. CPC H02J 1/00
USPC 307/11

(57) ABSTRACT

Disclosed herein is a network apparatus with a common power interface. The network apparatus mechanically connects to a power adapter via an electrical connector, and transfers the power to other electronic device via an electrical port in addition to taking power for the apparatus. In accordance with one of the embodiments of the invention, the apparatus substantially includes a control unit for processing the inner signals and data of the apparatus, and a communication module for processing the wired or wireless communication. A common power interfacing module is particularly introduced to processing the power allocation from the power adapter. A power management unit is also incorporated to managing the power inside the network apparatus, for example taking power for the operation of the apparatus. According to one further embodiment, the network apparatus is a routing device capable of connecting with external storages.

### BACKGROUND

1. Technical Field

The present invention is related to a network apparatus having a common power interface, in particular, the invention is to the network apparatus including an internal common power interfacing circuit for interfacing an external power and simultaneously powering an electronic device.

2. Description of Related Art

FIG. 1 shows a schematic diagram of installation of a network IP sharing device in a conventional art. The shown IP sharing device 10 is such a router serving wire or wireless network connection. An external computer device, such as a terminal computer device 14 or a notebook computer 16, may connect to the IP sharing device 10 over a wireless communication technology. The IP sharing device 10 is in charge of interfacing the external network such as network over ADSL or 3G/4G communication for the external computer device. The IP sharing device 10 is powered as plugged to the shown outlet 12 via a power adapter 101.

In some widespread multi-function network routers, USB port may be provided for connecting with the external storage device for sharing the storage over network. This storage-shared scheme may be implemented as a network disk, or a sharing mechanism built in an internal network for mutually accessible to each other.

### SUMMARY

Disclosure in accordance with the present invention is related to a network apparatus with a common power interface. The network apparatus includes an electrical connector interfacing with an external power adapter. Mechanically, this electrical connector includes a joint member for connecting with the power adapter. In addition to the power supplied to the apparatus retrieved via this electrical connector, one further electrical port of the network apparatus is used to direct power to another external device.

According to one of the embodiments of the invention, the network apparatus includes a control unit for processing internal signals and data, a communication module for conducting wire or wireless communication signals over the related protocols, a common power interfacing module, and a power management unit for allocating power in the network apparatus.

The common power interfacing module is provided for the network apparatus to electrically connect with a power adapter. The related circuitry includes a power control circuit, an electrical connector for bridging the power adapter, and an electrical port being a power line for the external electronic device. The network apparatus takes electricity via the electrical connector. Via the electrical port, the network apparatus may supply power to the external electronic device from the power adapter.

In one exemplary embodiment, the network apparatus is implemented as a routing device. The communication module therein provides wire or wireless connection for the electronic device to connect with the network. In which the communication module may preferably be a wireless communication module for serving the wireless connection for the device.

In an example of the network apparatus equipped with a USB, the mentioned electrical connector of the common power interfacing module may be a male connector of the USB, and the electrical port is to be a female connector.

One further embodiment of the present invention shows a network apparatus providing a network access service for external storage medium through the common power interface. The external storage medium may be a memory card or any type of the conventional external storage device. Since the apparatus may simultaneously provide one or more accessible storage medium, an access path selection unit is introduced for the network apparatus to conduct one selected access path in response to an electrical signal of each medium connecting member.

### BRIEF DESCRIPTION OF THE DRAWINGS

FIG. 1 schematically shows installation of an IP sharing device of the conventional technology;

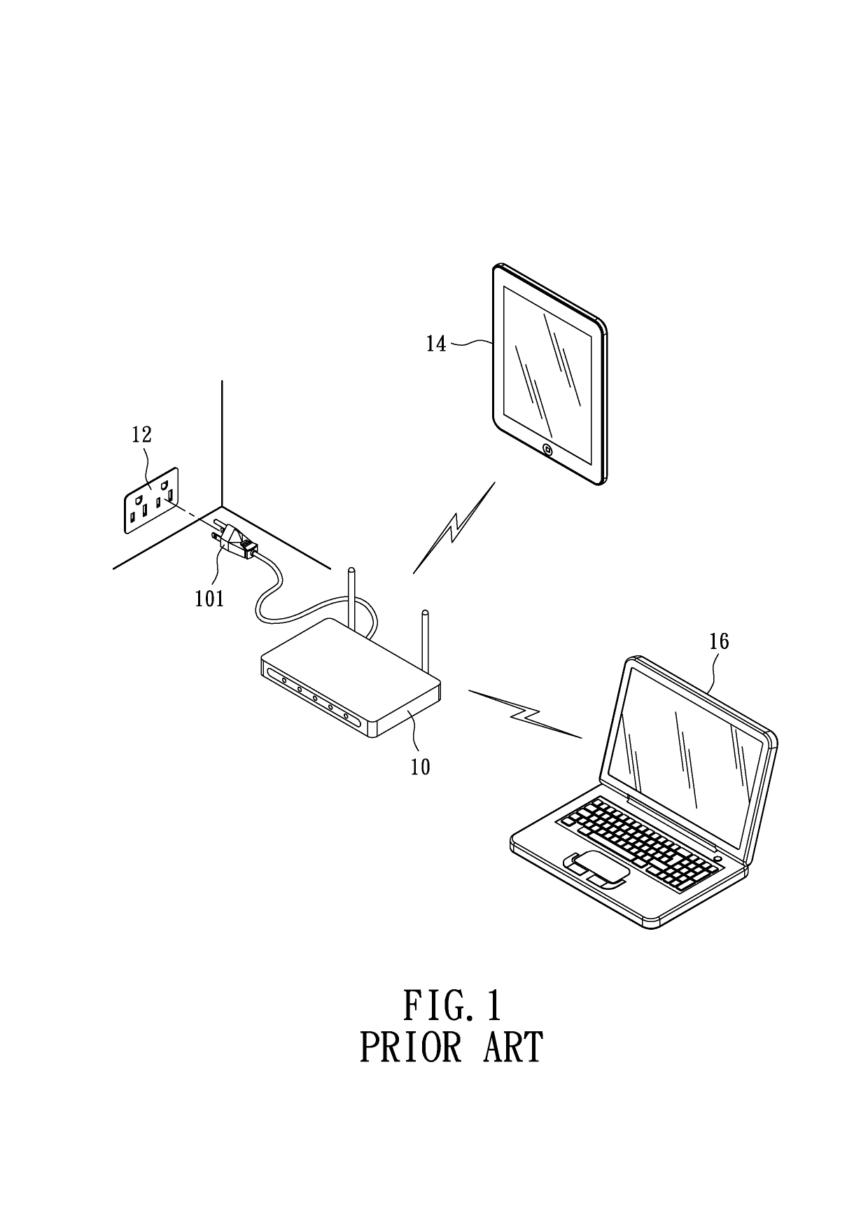

FIG. 2 shows a schematic diagram of the network apparatus with a common power interface in one embodiment of the present invention;

FIG. 3 illustrates relation of external connection of the network apparatus in accordance with the present invention;

FIG. 4 schematically shows a first embodiment of circuit blocks illustrating the network apparatus in accordance with the present invention;

FIG. 5 schematically shows a second embodiment of the circuit blocks illustrating the network apparatus in accordance with the present invention;

FIG. 6 shows a schematic diagram illustrating the network apparatus having a common power interface in one embodiment of the present invention;

FIG. 7 shows a schematic diagram illustrating a common power interfacing module of the network apparatus in one embodiment of the present invention;

FIGS. 8A and 8B schematically show the connection of the network apparatus having a common power interface and a power adapter in one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

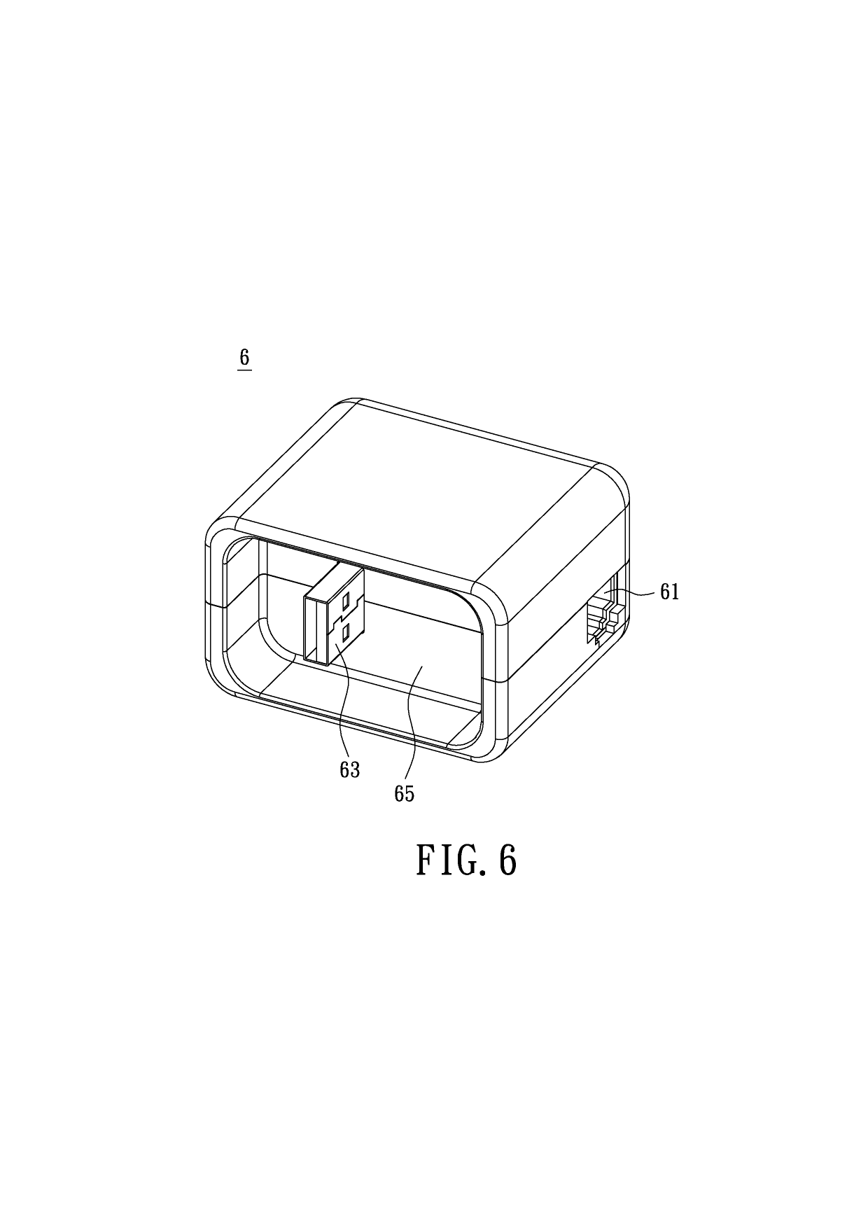

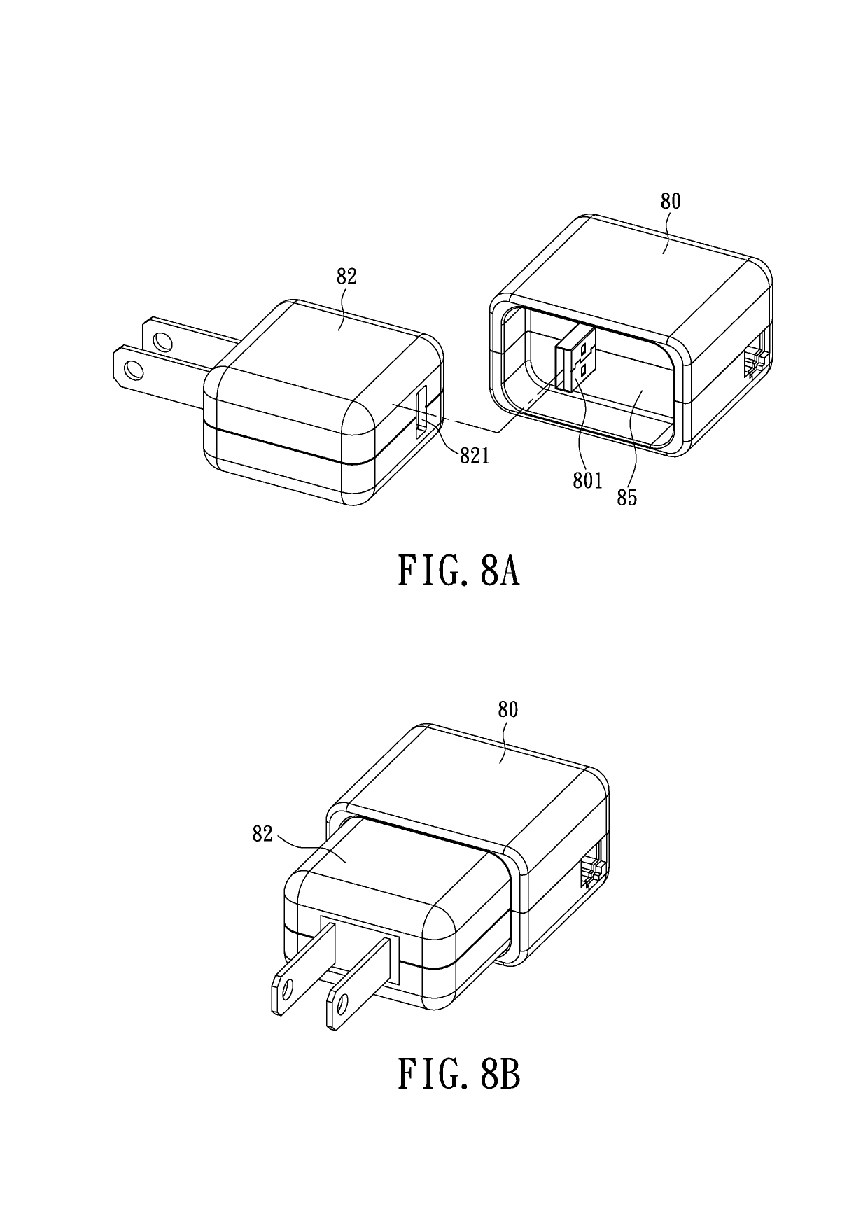

A network apparatus with a common power interface is provided in the disclosure. The network apparatus includes a joint member for connecting to a power adapter. The design of the joint member is referred to the reference shown in FIG. 6, FIG. 8A or FIG. 8B. One of the objectives of the invention is to reduce the unnecessary traditional connector or wire. Further, by the other end of the network apparatus, power may still be supplied to the other electronic device. It is noted that the mentioned power adapter jointed to the claimed network apparatus is the original power supply for the electronic device.

To the purpose of sharing power with one other electronic device, an internal common power interfacing circuit of the network apparatus is provided. By this internal common power interfacing circuit, the power may simultaneously be supplied to both the network apparatus and the electronic device which is electrically connected to the network apparatus.

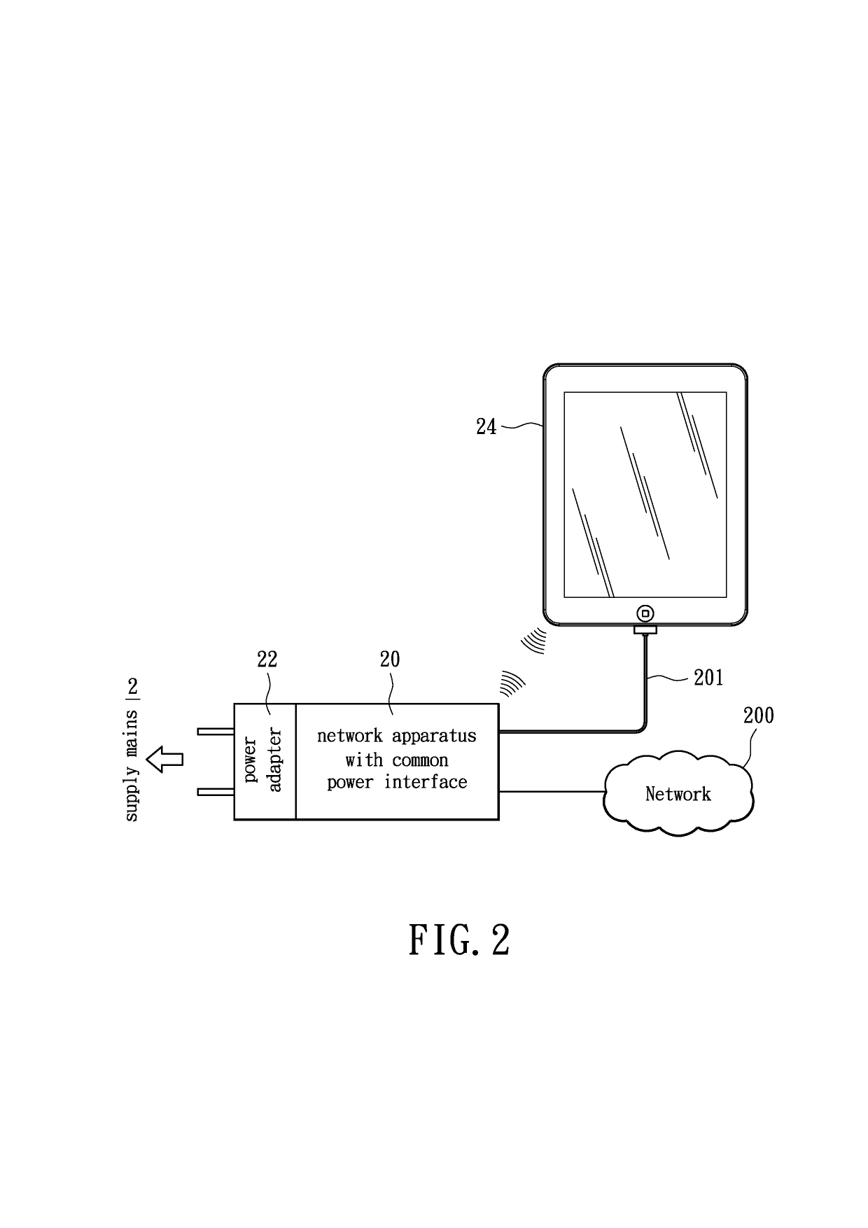

Reference is made to FIG. 2. The diagram of the embodiment of the network apparatus having a common power interface schematically shows a network apparatus 20, which is structurally connected to a power adapter 22. It is noted that the power adapter 22 is the main device bridging the supply mains 2.

The network apparatus 20 is preferably a device for interfacing the network, and is such as a router. A communication module (not shown) is necessarily installed in the network apparatus for serving communication signals in compliance with wire or wireless protocols. In practice, a connecting port (wire or wireless) is provided for the apparatus to connect with network 200, and also serving the external electronic device the wireless connection service for routing the packets to network 200.

According to the current embodiment, the network apparatus 20 takes power from the power adapter 22, and able to direct power to other one terminal computer device 24 via an interfacing circuit (not shown) for the common power supply. The terminal computer device 24 may be any type of the electronic device such as the home appliance, computer equipment, or any personal portable device.

The terminal computer device 24 may accordingly takes power from the claimed network apparatus 20 over a power line 201. However, the terminal computer device 24 may still be powered directly from the power adapter 22 while it is not connected to the network apparatus 20. In particular, this terminal computer device 24 may simultaneously use the wireless connection service performed by the network apparatus 20 as taking the apparatus 20's power. The terminal computer device 24 wirelessly gets on the network 200 and accesses the resource.

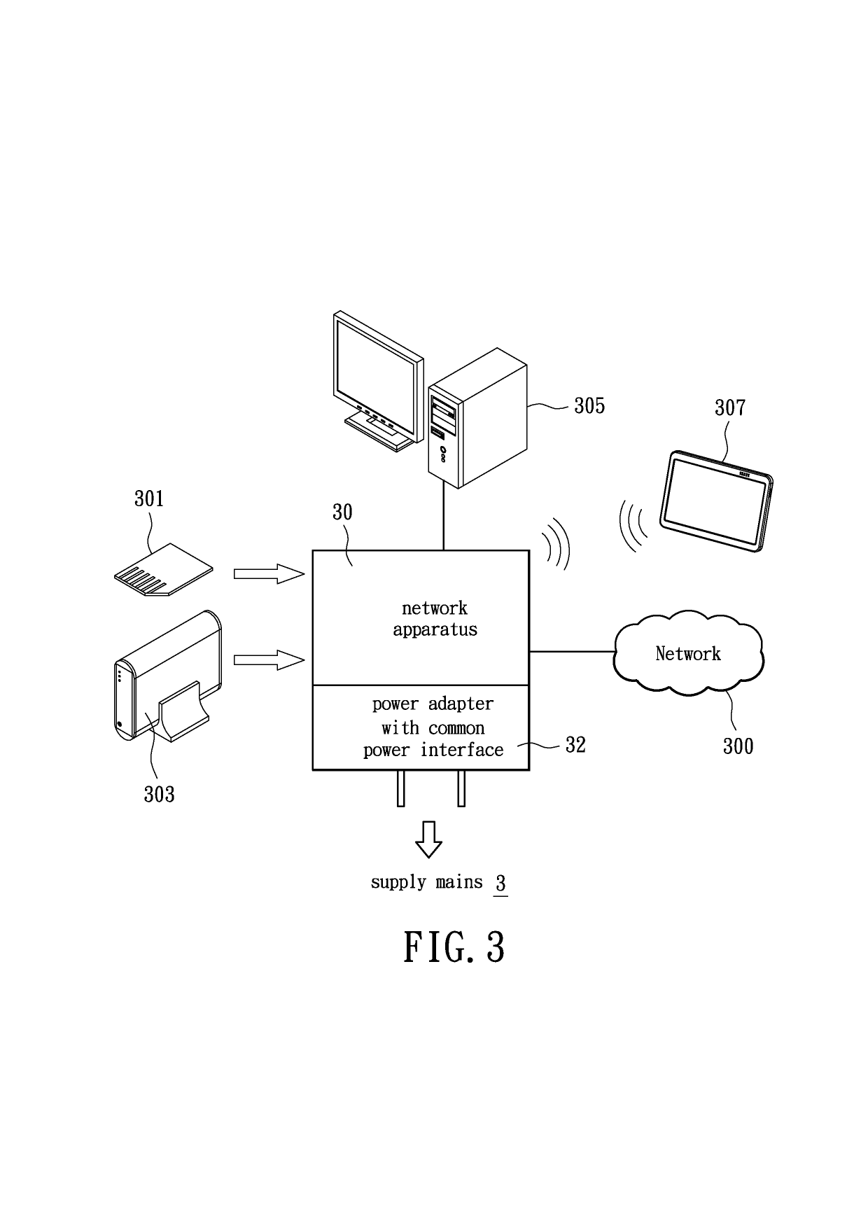

In addition to the network service conducted by the network apparatus for the nearby electronic devices, the apparatus provides network-based storage service for the electronic devices while the apparatus connects with the external storage medium via its own connecting port. The related embodiment is referred to FIG. 3 which illustrates the relationship of the network apparatus linked with the external devices via a common power interface.

A network apparatus 30 shown in the diagram is mechanically connected to a power adapter 32 which is connected with supply mains 3. The power adapter 32 supplies the power to the network apparatus 30. Reference is again to FIG. 2, the network apparatus 30 may accordingly provide wireless network access service to network 300 for the terminal computer device 307.

The network apparatus 30 is operated to provide service of network storage. The network apparatus 30 is exemplarily combined with a wireless network device, an independent power supply, a card reader, and a device for interfacing the external storage. The network apparatus may not be limited to be a network router, gateway or other like device. For example, the network apparatus' provision may allow the portable device exemplarily without any external connecting port to get on network if the network apparatus is implemented as a wireless network router. The portable device is such as a smartphone or a tablet computer, and able to access the external storage medium through the router-type network apparatus. The external storage medium may be a memory card, an external hard disk, or an external CD drive.

In one of the embodiments, a memory card 301 and an external storage device 303 are externally connected to the network apparatus 30 via the connecting port. Therefore the network apparatus 30 is provided with its own connectivity allowing the connected terminal computer device 307 to access the storage medium over network. In an exemplary example, the communication protocols supported by the network apparatus 30 are such as HTTP file server in compliance with hypertext transfer protocol and FTP file server with file transfer protocol. In which, the HTTP file server is preferably provided for the memory to conduct file transfer service, and the FTP file server is an access service of file folders. In general, the file formats such as, not limited to, FAT, FAT32, NTFS, exFAT and the like are for the various platforms applicably.

The above-described network apparatus is configured to have a common power interface that is associated with at least two types of interfaces provided for accessing the external storage medium. The provided network communication renders a remote data access service which is simultaneously applicable to a plurality of terminal devices over network. The terminal device is preferably personal computer, tablet computer, smartphone or any network-based electronic device. The network apparatus is exemplarily the portable, independently-operating, or the device capable of functioning wireless communication.

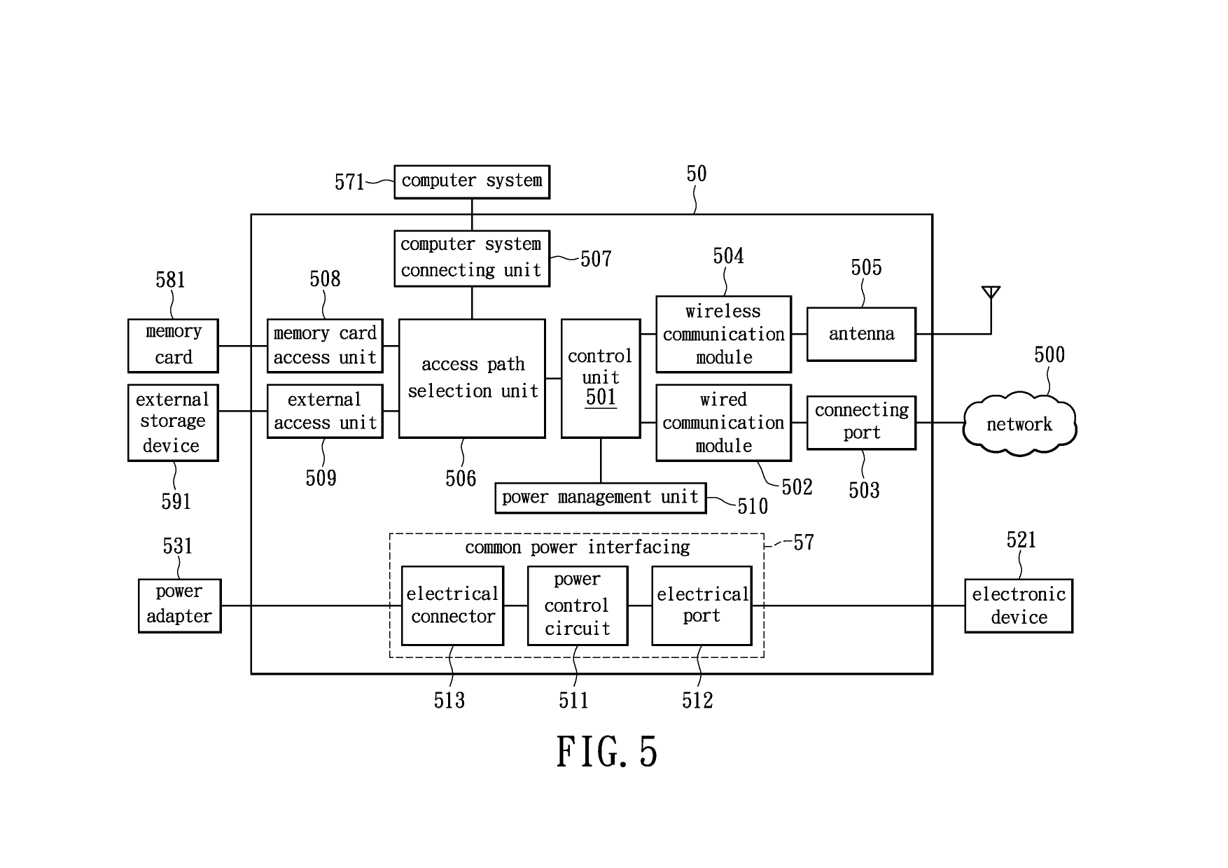

According to one of the embodiments in the disclosure, the network apparatus includes at least one access interface for a memory card described in FIG. 5. This access interface is such as a card reader which is in support of energy conservation and hot-swapping. One further access interface, again as shown in FIG. 5, of the network apparatus is provided for accessing an external storage device. This access interface for the external storage device is such as Universal Serial Bus (USB), Peripheral Component Interconnect (PCI), PCI Express, Firewire, or Thunderbolt port.

The network apparatus 30 is also allowed to link a computer system 305 directly via one more interface shown in the figure. The legacy USB is one of the solutions to implement the interface for the network apparatus 30 to link the computer system 305. Over this connection, the computer system 305 is operated to conduct configuration of the network apparatus 30, for example setting the internal operating parameters. Also, the network apparatus 30 may be implemented as a modem or a router that is served for the computer system 305 to get on the network 300.

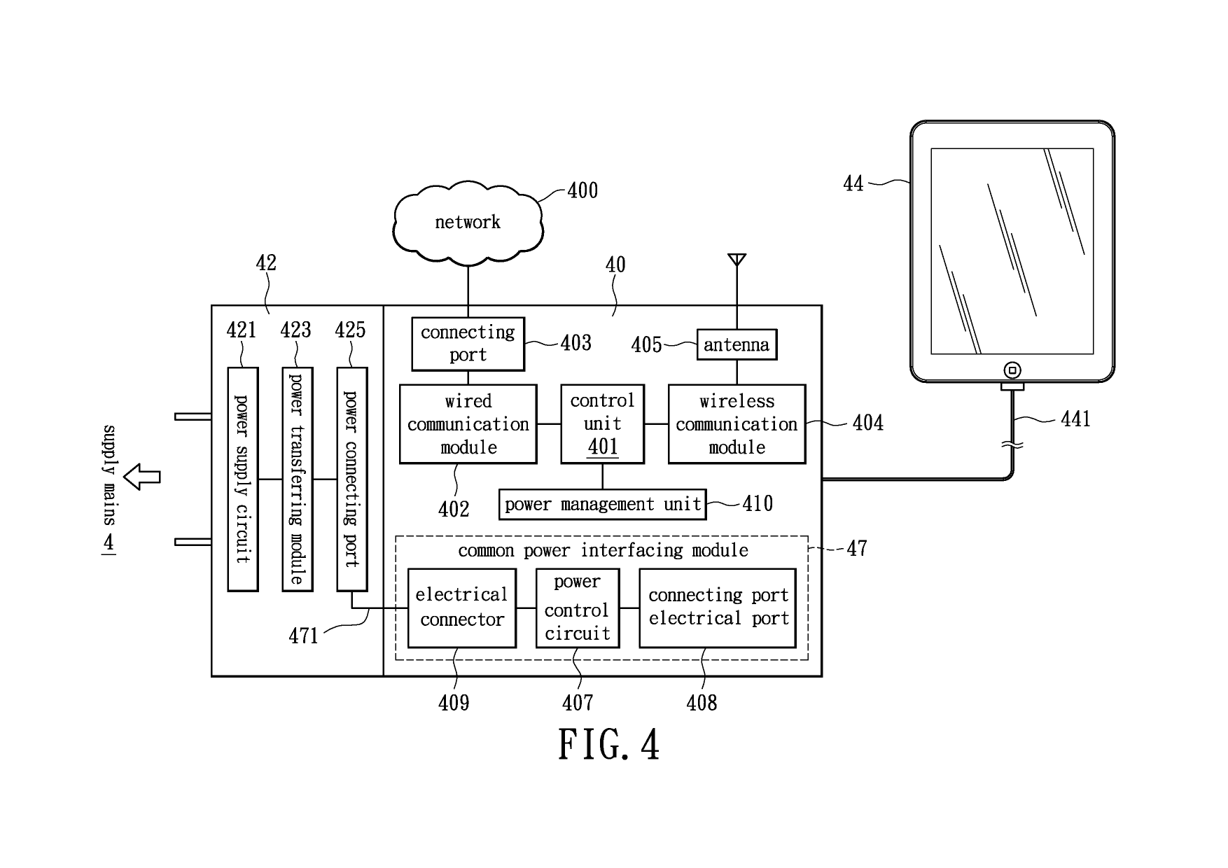

FIG. 4 next shows a block diagram illustrating network apparatus having the common power interface in one embodiment of the present invention.

The shown network apparatus 40 exemplarily includes a control unit 401 which is used to process the internal signals and data intercommunicated with the internal components. The internal components, electrically connected with the control unit 401, are such as a communication module including the circuits relating the wire or wireless communication protocols, a power management unit 410 and a common power interfacing module 47.

The network apparatus 40 may be a network routing device which is associated with the internal wire or wireless routing circuits or related firmware. The communication module is the circuit for processing the communication signals over the wire or wireless communication protocols. The communication module may involve a wired communication module 402 for serving the wire network service. The network apparatus 40 is linked with network 400 via a connecting port 403, which is exemplarily a conventional RJ-45 connecting port.

Further, the communication module may also include a wireless communication module 404 for serving the wireless network service for at least one terminal computer device 44 over an antenna 405 of the module 404. In one embodiment, the terminal computer device 44 can be allowed to access network through the routing function provided by this network apparatus 40.

Through the mentioned common power interfacing module 47, the network apparatus 40 allows its connected power adapter 42 to power the external device via electric line. The common power interfacing module 47 includes a power control circuit 407 which is in charge of power delivery and handling power allocation. Furthermore, two terminals of the power control circuit 407 are electrically connected to an electrical connector 409 and an electrical port 408 respectively. In which the electrical connector 409 is the terminal externally connected to the power adapter 42 for the network apparatus 40. USB is a preferable port to the power adapter 42. In detail, an A-type male connector of USB is one solution of the electrical connector 409. The internal installation of a second power line 471 is referred to the figure.

Still further, the electrical port 408 is the port for the network apparatus 40 to supply power to the external electronic device such as the shown terminal computer device 44. The electrical port 408 is similarly a port of USB. A female connector of USB line shown as a first power line 441 is preferred to implement the electrical port 408.

By installing the above-described electrical connector 409 or/and electrical port 408, the network apparatus 40 may provide the wireless network service and routed to wired network 400 for the terminal computer device 44, and on the other hand to power or charge the terminal computer device 44. The first power line 441 is used to conduct the powering or charging operation.

The power management unit 410 installed in the network apparatus 40 governs the internal power allocation. Since the power management unit 410 is electrically connected to the control unit 401 and the common power interfacing module 47, the network apparatus 40 may also take power through this common power interfacing module 47.

This network apparatus 40 is associated with the power adapter 42 through a joint member. In the power adapter 42, the main circuits included are such as a power supply circuit 421, a power transferring module 423, and a power connecting port 425. The power supply circuit 421 is the main circuit for the apparatus 40 to link supply mains 4, in particular the source is alternate current (AC). The power transferring module 423 then performs AC-to-DC power conversion. Since the network apparatus 40 is mechanically connected with the power adapter 42, the power adapter 42 uses its power connecting port 425 to connect to an electrical connector 409 of the common power interfacing module 47.

Reference is next made to FIG. 5. FIG. 5 depicts a block diagram illustrating the circuits implementing the network apparatus having the common power interface in one embodiment of the invention.

The common power interfacing module 57 installed in the network apparatus 50 is the main member linked with the power adapter 531. The apparatus 50 serves network access service of the external storage medium over a network. The described external storage medium may be many and such as the shown memory card 581 and external storage device 591. An access path selection unit 506 installed in the network apparatus 50 is used to make selection of one access path in response to electrical signal of the connecting member for the various storage.

In one exemplary example, the memory card 581 may be plugged to the apparatus 50 through a slot constituted of a card-reading member. The type of the card-reading member is configured to comply with a supported memory card 581. Further, a combo-type slot may be used to accord the various types of the memory cards (581). On the other hand, USB is one of the preferable solutions to implement the interface for the external storage device 591. It is noted that the conventional Firewire, Thunderbolt, PCI Express, or UART may also be the interface for the external storage device 591.

The network apparatus 50 is provided for the nearby electronic device or personal computer system to access network by the wireless network service. The network service is applicable to the devices such as tablet computer and smart phone with poor capability of expanding the external storage. One of the objectives of the claimed network apparatus 50 is to provide the expandable storage for the mentioned devices. Not only the network apparatus 50 includes the interface for the memory card 581, but also an access interface for the external storage device 591. The mentioned USB is preferably used for plugging an external hard disk, a disk array, a disk drive, or even the Network-Attached Storage (NAS). These types of the storage medium are provided for the electronic device to access one of the external storage medium.

In the present example, the network apparatus 50 includes a control unit 501 for processing the internal electrical signals and controlling the inside units. The control unit 501 in the claimed network apparatus 50 is particularly used to convey packets and conduct packet transferring among the network domains.

The network apparatus 50 may be implemented as a network routing device for processing packet routing among the terminal computer devices. The control unit 501 and communication module are the main circuits to perform packet routing. The data packets forwarded among the different network segments are transferring via the communication module. The network apparatus 50 includes a wired communication module 502 for processing the Ethernet network packets on the network 500 over the connecting port 503. A wireless communication module 504 for handling the wireless packets may also be included in the apparatus 50. While the wireless communication module 504 is activated, an antenna 505 is used to convey the wireless signals provided for the electronic device 521 to conduct the wireless service. The packets over the wireless network may be forwarded to the wire network by this network apparatus 50.

As shown in the diagram, the network apparatus 50 provides the at least two connecting ports. In which, one of the ports is of a memory card access unit 508 which is configured to provide an interface for connecting the memory card 581. One other port is of an external access unit 509 and used to connect with the external storage device 591. The access path selection unit 506 of the network apparatus 50 is electrically connected with the control unit 501. This access path selection unit 506 is configured to make a selection of the access path for the external terminal device (wireless terminal device 521 or the like) to access the memory card 581 or the external storage device 591.

In an exemplary example, while the memory card 581 is plugged to the network apparatus 50 via the memory card access unit 508, the access path selection unit 506 acknowledges there is a memory card (581) plugged to the apparatus 50 in response to the electrical signal related to the plugged memory card 581. The access signals, by the control unit 501, under the circumstance are forwarded to the memory card access unit 508 for allowing the terminal device to access the content in the memory card 581.

On the contrary, if the apparatus 50 acknowledges that there is no memory card 581 plugged, the access path selection unit 506 determines if any external storage device 591 is connected to the apparatus 50 through the external access unit 509. In which the selection unit 506 determines the relation of connection based on the electrical signals generated from the external access unit 509. The external access unit 509 exemplarily includes a connecting port of a specific interface and a related control circuit, for example the USB and a USB controller for processing the data delivered through USB. For example, the control unit 501 is electrically connected to the external storage device 591 via the access path selection unit 506 and the external access unit 509 for acquiring the information related to the external storage device 591. The information is such as the type, capacity, or file format of the storage device.

According to one of the embodiments, the access path selection unit 506 may be implemented as an intelligent circuit which is able to itself determine the access path. The access path selection unit 506 may simultaneously acquire the signals of the control circuits over the access paths. The control circuit may exemplarily be USB control IC or memory card control IC. The process of determination of the access path made by the access path selection unit 506 is configurable. In an exemplary example, for determining the access path, the access path selection unit 506 may detect the electrical signals over the connecting ports respectively. A memory card access unit 508 may be installed in the access path selection unit 506 for detecting the memory card access unit 508. A signal detection unit (not shown) is also installed in the access path selection unit 506 for detecting any plugged external storage device. The signal detection unit is configured to connect to the circuit of every connecting port. The signal detection unit preferably uses the electrical signals of pins of the connecting port to make the determination. In one of the embodiments, the control unit 508 of the memory card may have a connection detecting circuit integrated with the access path selection unit 506.

In one further embodiment of the present invention, the network apparatus 50 includes a computer system connecting unit 507 which establishes a connection between a computer system 571 and the control unit 508. The computer system connecting unit 507 provides a port for supplying power to the apparatus 50. The legacy USB is a port to transfer electric power, by which the computer system 571 supplies power to the connected device. The network apparatus 50 takes power from the connected computer system 571, and simultaneously provides network service including packet routing and forwarding for the connected system 571.

Next, the power management unit 510 electrically connected with the control unit 501 is to govern the power allocated to operate the apparatus 50. The power allocation is performed onto every circuit components in the apparatus 50. In one embodiment, the power management unit 510 is also electrically connected to the connecting members for the at least two external storage medium of the claimed network apparatus. The connecting members are such as the memory card access unit 508 and the external access unit 509. The power management unit 510 performs the power allocation according to the status of connection of the external storage medium over the connecting members, and the status is based on the information made by the access path selection unit 506. Therefore, the power management unit 510 allows the network apparatus to be operated with minimum power consumption.

In accordance with the embodiment of the present invention, for drawing the power supply, the power management unit 510 is electrically connected to the common power interfacing module 57 for the network apparatus 50 to associate with the power adapter 531 in addition to connected with the control unit 501 and the connecting members.

The common power interfacing module 57, in detail, includes a power control circuit 511 which is in charge of processing the signals bridging the power supply and the related connecting ports. The power control circuit 511 is electrically connected with the power management unit 510, and thereby to convey the power supplied to apparatus 50.

Two terminals of the power control circuit 511 are electrically connected to the external devices respectively. In which, one terminal of the power control circuit 511 is such as an electrical connector 513 of the power adapter 531 associated with the common power interfacing module 57. The other one is an electrical port 512 directed over the power line to the external electronic device. In one exemplary embodiment, the common power interfacing module 57 may be the circuit module of USB. The electrical connector 513 may be implemented as a male connector of USB, and the electrical port 512 is as a female connector thereof.

FIG. 6 shows a schematic diagram of the network apparatus in one embodiment of the present invention.

According to the diagram, a network apparatus 6 is shown as a device having a hollow portion in appearance. A wired connecting port 61 exemplarily in compliance with RJ-45 connector is installed. One side of the hollow portion is installed with an electrical connector 63 associated with the power adapter. This hollow portion is exemplarily a joint member 65 of the power adapter in combination with the network apparatus 6. In the present embodiment, the electrical connector 63 is preferably a USB port, and especially an A-type male connector. Through this A-type male connector, the network apparatus 6 may take power from the external device. On the other side of the hollow portion (not shown in this diagram), a female connector is installed for supplying power to the connected electronic device. The network apparatus 6 may be directly power-supplied by the power adapter, and also transfer power to the external device.

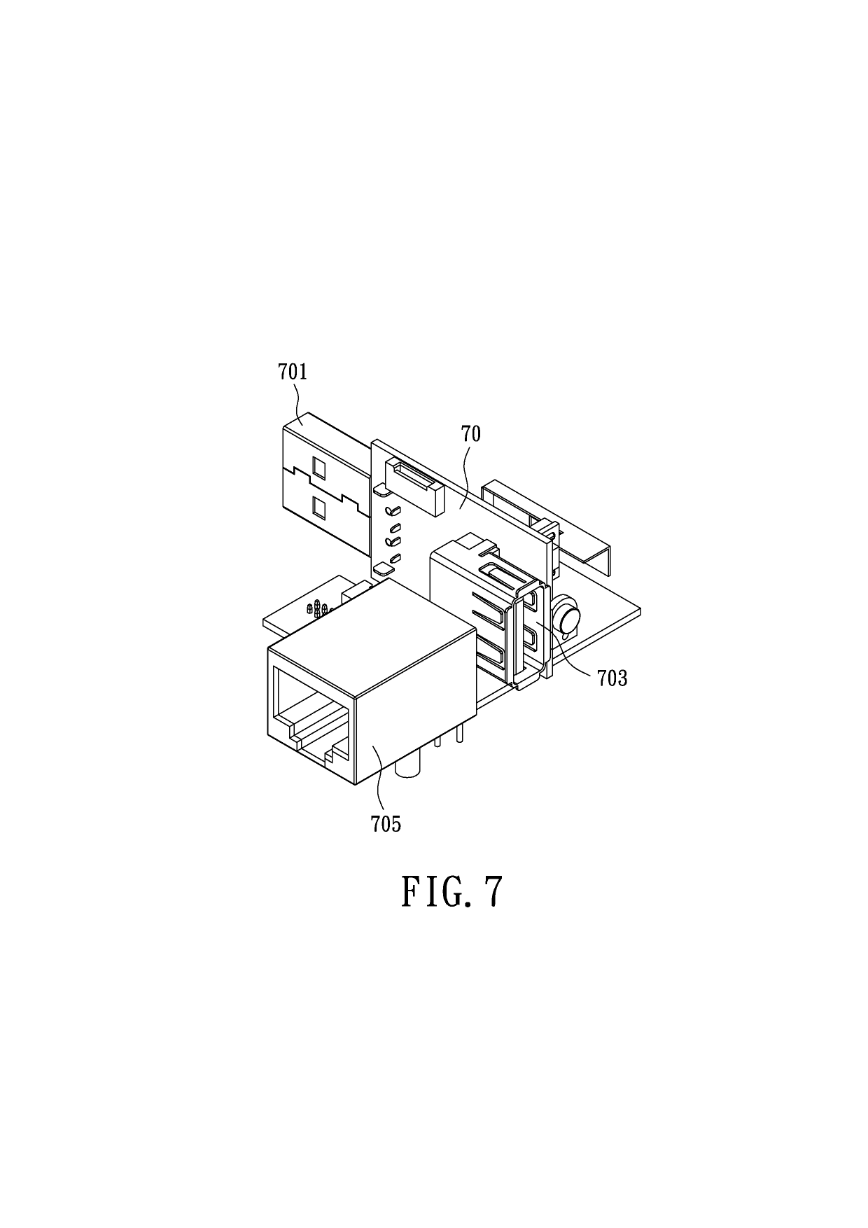

One of the embodiments of the network apparatus having the common power interfacing module is exemplarily shown in FIG. 7. The circuits for implementing the common power interfacing module 70 of the network apparatus are described in a circuit board. One major objective of the common power interfacing module 70 is to control power allocation made to the power adapter, including allocating power to operate the network apparatus, and also to the electronic device.

Furthermore, the two ends of the common power interfacing circuit 70 are respectively the USB-based electrical connector 701 and device-end power output port 703. According to the specification of Universal Serial Bus, USB is capable of transmitting data and delivering power at the same time. To function the power supply, the electrical connector 701 electrically connected to the power adapter is specified to a male connector. On the contrary, the device-end power output port 703 can be female connector for supplying power to external.

The common power interfacing circuit 70 may be integrated with the circuits of the network apparatus. In the diagram, the wired connecting port 705 and the other components are associated.

FIG. 8A next shows a schematic diagram illustrating an embodiment of the connection between the network apparatus and the power adapter.

The shown power adapter 82 is directly connected with supply mains. The power adapter 82 structurally includes a female connector, such as USB connector, for connecting and power-supplying an external electronic device.

The network apparatus 80 includes a joint member 85 for associating with the power adapter 82. It is noted that the embodiment shown in the diagram is not limited to the present invention. The joint member 85 of the network apparatus 80 is configured to have a hollow portion. An electrical connector 801 for linking power supply is installed. The electrical connector 801 is preferably a male USB connector. The joint member 85 is designed to wrap up and electrically connected to the power adapter 82. One end of the network apparatus 80 is to bridge power to the power output port 821 of the electronic device.

FIG. 8B also shows one further embodiment of the combination of the network apparatus 80 and the power adapter 82 in accordance with the present invention. However, the description of the diagram is not limited to the present invention.

In summation of the above description, the network apparatus having the common power interface is particularly a device for serving network connection to others. Such as a router, the network apparatus is structurally connected with a power adapter. The common power interfacing circuit is adopted to transfer power supplied to other electronic devices over an electrical port and also operatively acquiring power from the power adapter.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A network apparatus with a common power interface, comprising:
a control unit configured to process internal signals and data in the network apparatus;
a communication module, electrically connected with the control unit, for processing signals of wire or wireless communication protocol in the network apparatus;
a common power interfacing module, electrically connected with the control unit, provided for the network apparatus electrically connected to a power adapter, and interfacing the power adapter to power the electronic device; and
a power management unit, electrically connected with the control unit and the common power interfacing module, configured to manage power allocation of the network apparatus, and obtain electric power via common power interfacing module for operating the network apparatus.

2. The network apparatus recited in claim 1, wherein the communication module includes:
a wired communication module, connected to a wire network via a connecting port; and
a wireless communication module, provided for at least one terminal computer device to conduct wireless communication via an antenna.

3. The network apparatus recited in claim 2, wherein the network apparatus is a routing device providing the at least one terminal computer device to conduct network connection and packet routing; the control unit and the communication module are main circuit for performing the packet routing; and the communication module is used to forward data packets between different network segments.

4. The network apparatus recited in claim 1, wherein the common power interfacing module includes:
a power control circuit electrically connected to the power management unit;
an electrical connector connected with the power adapter and electrically connected to the power control circuit; and
an electrical port, electrically connected with the power control circuit, providing a power line for the electronic device.

5. The network apparatus recited in claim 4, wherein the common power interfacing module is a circuit module of a universal serial bus.

6. The network apparatus recited in claim 5, wherein the electrical connector is a male connector of the universal serial bus; the electrical port is a female connector of the universal serial bus.

7. The network apparatus recited in claim 1, further comprising:
at least two connecting members for the network apparatus connecting to at least two external storage medium; and
an access path selection unit, electrically connected with the control unit and the at least two connecting members, configured to select an access path in response to electrical signal of the connecting members.

8. The network apparatus recited in claim 7, wherein the connecting members of the at least two external storage medium include:
a memory card access unit, provided for plugging a memory card; and
an external access unit, provided for connecting an external storage device;
wherein, in response to connection status of the external storage medium by the access path selection unit, the power management unit allocates power to the memory card access unit or the external access unit.

9. The network apparatus recited in claim 8, wherein the access path selection unit includes a signal detection unit for detecting electrical signal of the memory card access unit and the external access unit.

10. The network apparatus recited in claim 9, wherein the memory card access unit includes a connection detecting circuit integrated with the access path selection unit.
